(19) United States
(12) Patent Application Publication
(10) Pub. No.: US 2023/0400153 A1
(43) Pub. Date: Dec. 14, 2023

(54) HYDROGEN STORAGE DEVICE AND VEHICLE

(71) Applicant: TOYOTA JIDOSHA KABUSHIKI KAISHA, Toyota-shi (JP)

(72) Inventor: Syuji HIRAKATA, Toyota-shi (JP)

(21) Appl. No.: 18/302,074

(22) Filed: Apr. 18, 2023

(30) Foreign Application Priority Data
Jun. 13, 2022 (JP) 2022-094942

(51) Int. Cl. F17C 5/00; H01M 8/04082; H01M 8/04746; H01M 8/0438

(52) U.S. Cl. CPC F17C 5/007; H01M 8/04201; H01M 8/04753; H01M 8/04388; F17C 2221/012; F17C 2270/0171; F17C 2205/0142; F17C 2205/0326; F17C 2250/032; F17C 2250/0694; F17C 2250/043; F17C 2205/0352; F17C 2270/0184; F17C 2265/066; F17C 2205/0146; F17C 2250/034; H01M 2250/20

(57) ABSTRACT

A hydrogen storage device is included in a vehicle and is configured to store hydrogen. The hydrogen storage device includes: a plurality of receptacles configured such that a nozzle of the hydrogen filling device is connected thereto; a plurality of hydrogen tanks; a flow path through which hydrogen flows; a solenoid valve located in the flow path; and a control device. The flow path includes an independent first flow path and an independent second flow path. By opening and closing the solenoid valve, the independent first and second flow paths are switched between a state in which they communicate with each other and a state in which they do not communicate with each other. The control device is configured to control the solenoid valve and configured to perform a calculation for determining whether to open or close the solenoid valve, based on a condition of the hydrogen filling device.

### CROSS-REFERENCE TO RELATED APPLICATION

This application claims priority to Japanese Patent Application No. 2022-094942 filed on Jun. 13, 2022, incorporated herein by reference in its entirety.

### BACKGROUND

### 1. Technical Field

The present disclosure relates to a hydrogen storage device mounted on a vehicle and a vehicle equipped with the hydrogen storage device.

### 2. Description of Related Art

Japanese Unexamined Patent Application Publication No. 2021-095982 (JP 2021-095982 A) describes a hydrogen filling method for filling an in-vehicle tank mounted on a vehicle with hydrogen supplied from a dispenser. This hydrogen filling method includes: an initial pressure measurement step S1 of measuring an initial pressure value of hydrogen that is introduced into the in-vehicle tank; and a capacity estimation step S2 of estimating the capacity of the in-vehicle tank after measuring the initial pressure value.

### SUMMARY

Commercial vehicles such as trucks and buses can be equipped with many hydrogen tanks in order to extend the travel distance. However, when there is only one filling port for hydrogen, the pipe length from the filling port to the hydrogen tanks is large. When the pipe inside diameter is small, pressure loss increases. This results in a low hydrogen filling rate. One solution to this is to provide a plurality of filling ports. However, since the hydrogen supply side is not necessarily compatible with multiple filling ports, there are cases where filling cannot be efficiently performed. In addition, if there is a pressure difference between the filling ports, filling of the hydrogen tank through the filling port having a lower pressure is completed at a low tank pressure. Therefore, there are cases where the hydrogen tanks are not sufficiently filled with hydrogen by a single filling.

The present disclosure provides a hydrogen storage device capable of efficiently and sufficiently filling hydrogen tanks with hydrogen in a vehicle equipped with a plurality of receptacles and a plurality of hydrogen tanks.

A hydrogen storage device according to a first aspect of the present disclosure is included in a vehicle using hydrogen as fuel, and is configured to store hydrogen supplied from a hydrogen filling device. The hydrogen storage device includes: a plurality of receptacles configured such that a nozzle of the hydrogen filling device is connected to each of the receptacles; a plurality of hydrogen tanks; a flow path through which hydrogen flows from the receptacles toward the hydrogen tanks; a solenoid valve located in the flow path; and a control device. The receptacles include a first receptacle and a second receptacle. The hydrogen tanks include at least one first hydrogen tank and at least one second hydrogen tank. The flow path includes an independent first flow path connecting the first receptacle and the at least one first hydrogen tank, and an independent second flow path connecting the second receptacle and the at least one second hydrogen tank. By opening and closing the solenoid valve, the independent first flow path and the independent second flow path are switched between a state in which the independent first flow path and the independent second flow path communicate with each other and a state in which the independent first flow path and the independent second flow path do not communicate with each other. The control device is configured to control the opening and closing of the solenoid valve, and is configured to perform a calculation for determining whether to open or close the solenoid valve, based on a condition of the hydrogen filling device connected to at least one of the receptacles.

In the hydrogen storage device according to the first aspect of the present disclosure, the flow path may include a third flow path connecting the independent first flow path and the independent second flow path, and the solenoid valve may be located in the third flow path.

In the hydrogen storage device according to the first aspect of the present disclosure, the control device may be configured to perform control to open the solenoid valve when there is at least one of the receptacles to which hydrogen is not supplied.

The hydrogen storage device according to the first aspect of the present disclosure may further include a pressure sensor that is configured to measure a pressure in the flow path. The control device may be configured to acquire a pressure value from the pressure sensor, and may be configured to perform control to open the solenoid valve when an absolute value of a pressure difference between the independent first flow path and the independent second flow path is equal to or greater than a predetermined value.

A vehicle according to a second aspect of the present disclosure may include: the above hydrogen storage device; and a fuel cell system configured to be supplied with hydrogen from the hydrogen tanks of the hydrogen storage device to generate electricity.

According to the present disclosure, hydrogen tanks can be expected to be efficiently and sufficiently filled with hydrogen in a vehicle equipped with a plurality of receptacles and a plurality of hydrogen tanks.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 schematically shows a vehicle 1;

FIG. 2 illustrates a hydrogen filling device 50;

FIG. 3 illustrates a hydrogen storage device 20;

FIG. 4 illustrates a control device 30;

FIG. 5 illustrates hydrogen filling control S10 according to Mode 1; and

FIG. 6 illustrates hydrogen filling control S20 according to Mode 2.

### DETAILED DESCRIPTION OF EMBODIMENTS

### 1. Vehicle

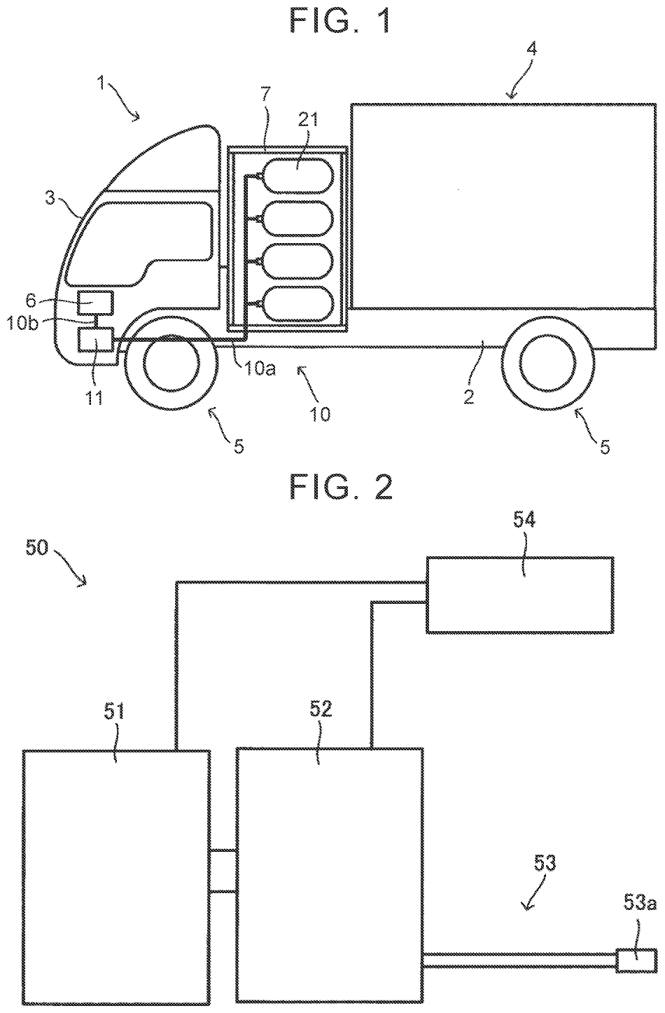

FIG. 1 schematically shows a vehicle 1 equipped with hydrogen tanks 21. Since a hydrogen storage device 20 will be described later with reference to a different figure, FIG. 1 shows only the hydrogen tanks 21 of the hydrogen storage device 20. The vehicle 1 of the present embodiment is a large vehicle (truck), and includes a chassis 2, a driving portion 3 located on a front part of the chassis 2, a bed portion 4 located on a rear part of the chassis 2, wheel portions 5 mounted under the chassis 2, an electric motor 6 that drives the vehicle 1, and a fuel cell unit 10. Although a large vehicle is a truck in the present embodiment, the present disclosure is not limited to this, and is also applicable to buses etc. The present disclosure is not limited to large vehicles, and is also applicable to ordinary passenger cars.

The fuel cell unit 10 includes a fuel cell 11, hydrogen tanks 21, an air acquisition unit, not shown, and a hydrogen tank storage case 7. Hydrogen is supplied from the hydrogen tanks 21 housed in the hydrogen tank storage case 7 to the fuel cell 11 through a hydrogen supply pipe 10a, and air is supplied from the air acquisition unit, not shown, to the fuel cell 11. The fuel cell 11 generates electricity by oxidizing hydrogen with the supplied air (oxygen), and supplies the electricity to the electric motor 6 through an electric wire 10b to drive the electric motor 6. The vehicle 1 thus obtains propulsion.

Such driving of the electric motor 6 of the vehicle 1 by the fuel cell 11 using hydrogen as fuel is well known in the art.
As will be described later, the vehicle 1 of the present embodiment is equipped with a hydrogen storage device 20. The hydrogen storage device 20 receives hydrogen supplied from a hydrogen filling device 50 installed in a hydrogen refueling station and stores the hydrogen in the hydrogen tanks 21. The hydrogen tanks 21 are filled with hydrogen by the hydrogen storage device 20.

### 2. Hydrogen Filling Device

FIG. 2 schematically illustrates the hydrogen filling device 50 that supplies hydrogen to the hydrogen storage device 20.

The hydrogen filling device 50 includes: an accumulator 51 storing hydrogen; a compressor 52 that compresses (boosts) hydrogen discharged from the accumulator 51 into a pipe; a hydrogen supply pipe 53 that supplies the boosted hydrogen from the compressor 52 to the hydrogen storage device 20 of the vehicle 1; and a control device 54 that controls hydrogen supply. Hydrogen filling is performed by connecting a nozzle 53a at a distal end of the hydrogen supply pipe 53 to a receptacle 22 of the hydrogen storage device 20 of the vehicle 1.
One or more hydrogen filling devices 50 are installed in a hydrogen refueling station that supplies hydrogen. That is, there are hydrogen refueling stations with one hydrogen filling device 50 and hydrogen refueling stations with two or more hydrogen filling devices 50.

### 3. Hydrogen Storage Device

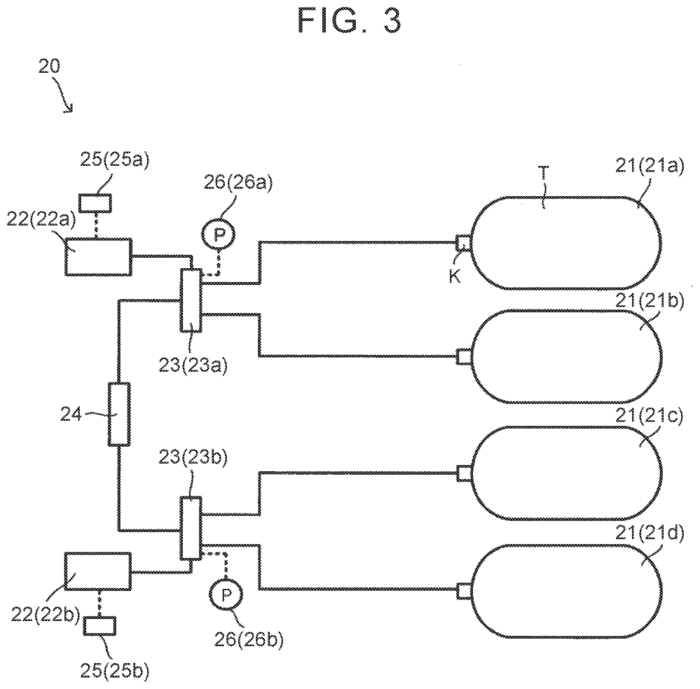

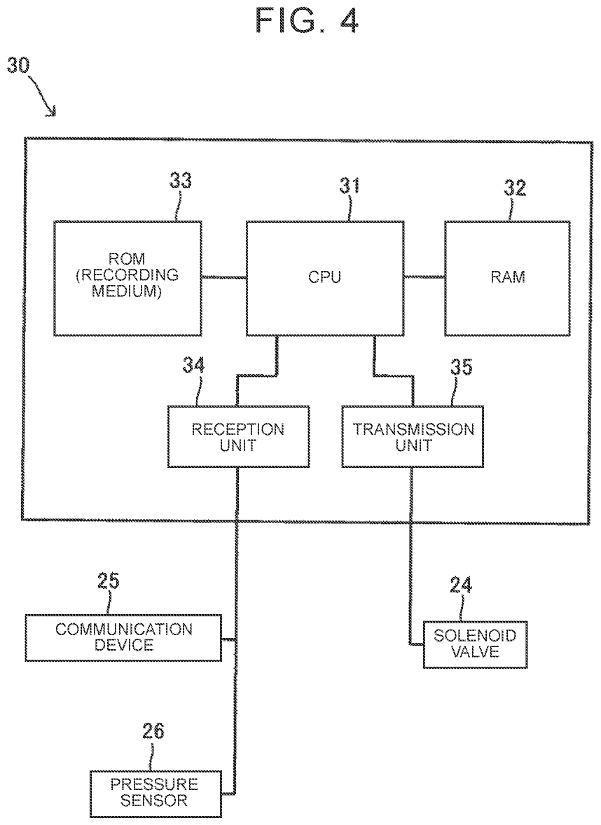

As described above, the vehicle 1 of the present embodiment is equipped with the hydrogen storage device 20. The hydrogen storage device 20 is a device for storing hydrogen. FIG. 3 conceptually shows the configuration of the hydrogen storage device 20 according to one embodiment. As can be seen from FIG. 3, the hydrogen storage device 20 of the present embodiment includes hydrogen tanks 21, receptacles 22, distributors 23, a solenoid valve 24, communication devices 25, and pressure sensors 26. As will be described later, these members are connected by pipes to form a flow path for hydrogen. Although not shown in FIG. 3, the hydrogen storage device 20 includes a control device 30 that controls these members (see FIG. 4).

### 3.1. Hydrogen Tank

The hydrogen tank 21 is a container for storing hydrogen, and hydrogen is supplied from the hydrogen tank 21 to the fuel cell 11.

The specific structure of the hydrogen tank 21 is not particularly limited, and a known structure that can be used as a hydrogen tank can be applied to the hydrogen tank 21. Typically, a hydrogen tank includes: a tank body T that is a portion for storing hydrogen; and a boss K that serves as a hydrogen inlet and outlet of the tank body T and to which a pipe is connected.

In the present embodiment, a plurality of hydrogen tanks 21 is provided (e.g., four hydrogen tanks 21), and each hydrogen tank 21 is filled with hydrogen. The present embodiment illustrates an example in which four hydrogen tanks 21 are disposed. These hydrogen tanks 21 are denoted by signs 21a, 21b, 21c, and 21d in order to distinguish them from each other. These hydrogen tanks 21 may all have the same capacity, or may include a hydrogen tank with a different capacity or hydrogen tanks with a different capacities. The hydrogen tanks 21a, 21b can be regarded as an example of the first hydrogen tank of the present disclosure, and the hydrogen tanks 21c, 21d can be regarded as an example of the second hydrogen tank of the present disclosure.

### 3.2. Receptacle

The receptacle 22 includes a hydrogen supply port that allows hydrogen to flow from the hydrogen filling device 50 into the hydrogen tanks 21 when the nozzle 53a of the hydrogen filling device 50 is connected to the receptacle 22 and the flow path in the hydrogen filling device 50 and the flow path in the hydrogen storage device 20 communicate with each other.

The specific shape of the receptacle 22 is not particularly limited, and the receptacle 22 in a known form can be used.

In the present embodiment, a plurality of receptacles 22 is provided (e.g., two receptacles 22). The present embodiment illustrates an example in which two receptacles 22 are provided. These receptacles 22 are denoted by signs 22a, 22b in order to distinguish them from each other. However, the present disclosure is not limited to this, and three or more receptacles may be provided. The receptacle 22a can be regarded as the first receptacle of the present disclosure, and the receptacle 22b can be regarded as the second receptacle of the present disclosure.

### 3.3. Distributor

The distributor 23 is a member that connects a plurality of flow paths to branching or merging. In the present embodiment, one distributor 23 is provided for each receptacle 22. That is, in the present embodiment, a distributor 23a is placed for the receptacle 22a, and a distributor 23b is placed for the receptacle 22b. The specific shape of the distributor 23 is not particularly limited, and the distributor 23 in a known form can be used.

### 3.4. Solenoid Valve

The solenoid valve 24 is a valve that can be quickly opened and closed by the force of an electromagnet, and is an ON-OFF valve that can be either fully opened (opened) or fully closed (closed). A known valve can be used as the solenoid valve 24.

### 3.5. Flow Path

The members described above are connected by pipes to form a flow path for hydrogen. Specifically, pipes are connected so that the receptacle 22a is connected to the distributor 23a and the flow path branches off at the distributor 23a into the hydrogen tank 21a, the hydrogen tank 21b, and the solenoid valve 24. Pipes are also connected so that the receptacle 22b is connected to the distributor 23b and the flow path branches off at the distributor 23b into the hydrogen tank 21c, the hydrogen tank 21d, and the solenoid valve 24. That is, the distributor 23a and the distributor 23b are connected via the solenoid valve 24, and are configured to communicate with each other when the solenoid valve 24 is opened, and not to communicate with each other when the solenoid valve 24 is closed. Therefore, the following two flow paths are individually formed when the solenoid valve 24 is in the closed state: an independent hydrogen filling flow path from the receptacle 22a that is one of the receptacles to the hydrogen tanks 21a, 21b that are a part of the hydrogen tanks (this flow path can be regarded as an example of the independent first flow path of the present disclosure), and an independent hydrogen filling flow path from the receptacle 22b that is another one of the receptacles to the hydrogen tanks 21c, 21d that are another part of the hydrogen tanks (this flow path can be regarded as an example of the independent second flow path of the present disclosure). When the solenoid valve 24 is opened, these independent flow paths communicate with each other to form a hydrogen filling flow path from the receptacle 22a to all the hydrogen tanks 21 and a hydrogen filling flow path from the receptacle 22b to all the hydrogen tanks 21. The flow path connecting the distributors 23a, 23b via the solenoid valve 24 can be regarded as an example of the third flow path of the present disclosure.

### 3.6. Communication Device

One communication device 25 is placed for each receptacle 22. Each communication device 25 is configured to transmit and receive information to and from the hydrogen refueling station and the hydrogen filling device 50. The hydrogen storage device acquires information on the hydrogen refueling station (hydrogen filling device 50) via the communication devices 25.

The specific form of the communication device 25 is not particularly limited, but an example of the communication device 25 is an infrared communication device. In the present embodiment, a communication device 25a is placed for the receptacle 22a, and a communication device 25b is placed for the receptacle 22b.

### 3.7. Pressure Sensor

One pressure sensor 26 is placed for each distributor 23. Each pressure sensor 26 measures the pressure in the flow path (hydrogen pressure) in a corresponding one of the distributors 23. That is, the pressure in each of the above independent flow paths is measured. The specific type of the pressure sensor is not particularly limited, and a known pressure sensor can be used.

In the present embodiment, a pressure sensor 26a is placed for the distributor 23a, and a pressure sensor 26b is placed for the distributor 23b.

### 3.8. Control Device

The control device 30 acquires information from the communication devices 25 and the pressure sensors 26, performs calculations, and for example, operates the solenoid valve 24 to perform control so that hydrogen filling is performed in a desired manner. As conceptually shown in FIG. 4, the control device 30 includes: a central processing unit (CPU) 31 that is a processor and performs calculations; a random access memory (RAM) 32 that serves as a work area; a read-only memory (ROM) 33 that serves as a recording medium; a reception unit 34 that is an interface through which the control device receives information either wired or wirelessly; and a transmission unit 35 that is an interface through which the control device 30 send information to the outside either wired or wireless.

The communication devices 25 and the pressure sensors 26 are connected to the reception unit 34 so that the control device 30 can receive information from the communication devices and the pressure sensors 26, and the solenoid valve 24 is connected to the transmission unit 35 so that the control device 30 can send a open or close signal to the solenoid valve 24.

The control device 30 stores a program for processing information from the communication devices 25 and the pressure sensors 26 to determine whether to open or close the solenoid valve 24 and operate the solenoid valve 24. In the control device 30, the CPU 31, the RAM 32, and the ROM 33 that are hardware resources cooperate with the program. Specifically, the CPU 31 reads the computer program recorded on the ROM 33 and executes it in the RAM 32 serving as a work area. The CPU 31 thus operates the solenoid valve 24 and implements an appropriate hydrogen filling mode. Information acquired or generated by the CPU 31 is stored in the RAM 32. A separate recording medium may be provided inside or outside the control device 30, and programs and various data may be recorded on this recording medium.

In the present embodiment, the control device 30 acquires information from the communication devices 25 and the pressure sensors 26 via the reception unit 34. Based on the acquired data, the control device 30 executes the computer program recorded on the ROM 33 or other recording medium and performs calculations while using, for example, a database recorded on the ROM 33 or other recording medium. The control device 30 thus determines whether to open or close the solenoid valve 24, and records the determination result on the RAM 32 or other recording medium. Determination as to whether to open or close the solenoid valve 24 will be specifically described in detail later. The determination result regarding whether to open or close the solenoid valve 24 is sent from the transmission unit 35 to the solenoid valve 24, and the solenoid valve 24 opens or closes according to this command.

Such a control device 30 can typically be a computer.

### 4. Hydrogen Filling Control

Next, hydrogen filling control will be described.

As described above, in the hydrogen storage device 20 of the present embodiment, the hydrogen filling flow paths between the receptacles 22 and the hydrogen tanks 21 can be changed (independent hydrogen flow paths can communicate with each other or can not communicate with each other) by switching the solenoid valve 24 between the open and closed states. The basic concept of opening and closing the solenoid valve 24 is as follows.

For example, the solenoid valve 24 can be opened in the following situations. The situations in which the solenoid valve 24 is opened are not limited to the following situations.

(A1) Limited Number of Hydrogen Filling Devices (Hydrogen Refueling Station)

When a vehicle is equipped with a plurality of receptacles but there is only one hydrogen filling device at the hydrogen refueling station, or when there are two or more hydrogen filling devices at the hydrogen refueling station but only one of them is available for use, hydrogen filling can be performed only with one receptacle. Therefore, the solenoid valve is opened to cause the independent flow paths to communicate with each other, so that all the hydrogen tanks can be filled with hydrogen through the one receptacle.

(A2) Failure of Nozzle of Hydrogen Filling Device or Receptacle

For example, if an O-ring of one of the receptacles is broken, or when there is a plurality of hydrogen filling devices but the nozzle of one of the hydrogen filling devices is broken, hydrogen filling cannot be properly performed due to hydrogen leakage etc. even when the nozzles of the hydrogen filling devices are inserted into the receptacles. In such a case, not all of the hydrogen tanks can be filled with hydrogen if the solenoid valve is kept closed. Therefore, the solenoid valve is opened to cause the independent flow paths to communicate with each other, so that all the hydrogen tanks can be filled with hydrogen through the receptacle (or receptacles) other than the broken receptacle.

For example, the solenoid valve 24 can be closed in the following situation. The situations in which the solenoid valve 24 is closed are not limited to the following situation.

The nozzle of the hydrogen filling device is connected to each of the receptacles, and in each independent hydrogen flow path, the hydrogen tanks allocated to each receptacle (e.g., the hydrogen tanks 21a, 21b allocated to the receptacle 22a) are filled with hydrogen. Hydrogen filling can thus be efficiently performed. In principle, when there is a plurality of hydrogen filling devices and hydrogen is supplied from each of the nozzles to the receptacles in the same manner, the hydrogen tanks can be efficiently filled with hydrogen by performing such hydrogen filling.

There may be cases where the solenoid valve 24 is switched between the open and closed states during hydrogen filling as will be described below.

Even the hydrogen filling devices installed at the same hydrogen refueling station may have a different hydrogen pressure from each other. For example, it is assumed that a hydrogen filling device 50A stores hydrogen at 70 MPa and a hydrogen filling device 50B stores hydrogen at 50 MPa, and the nozzle 53a of the hydrogen filling device 50A is connected to the receptacle 22a and the nozzle 53a of the hydrogen filling device 50B is connected to the receptacle 22b. In this case, if the solenoid valve 24 is kept closed until the end, the hydrogen tanks 21a, 21b can be filled with hydrogen up to 70 MPa but the hydrogen tanks 21c, 21d can only be filled with hydrogen up to 50 MPa.
Therefore, the solenoid valve 24 is initially closed to fill the hydrogen tanks 21a, 21b with hydrogen up to 70 MPa and fill the hydrogen tanks 21c, 21d with hydrogen up to 50 MPa. Thereafter, the solenoid valve 24 is opened to cause the independent hydrogen flow paths to communicate with each other. The hydrogen tanks 21c, 21d can thus be filled with hydrogen from the hydrogen filling device 50A, so that all the hydrogen tanks can be eventually filled with hydrogen up to 70 MPa.

As described above, the hydrogen tanks can be efficiently and sufficiently filled with hydrogen by switching the solenoid valve between the open and closed states based on whether filling can be performed according to the condition of the nozzles of the hydrogen filling devices or in order to compensate for insufficient filling of the hydrogen tanks with hydrogen due to the condition of the pressure.

Modes 1 and 2 will be shown below as specific examples. Hydrogen filling control in the modes described below is performed by the control device 30 processing the information acquired by the communication devices 25 and the pressure sensors 26 in the manner described above. Specifically, a computer program including steps corresponding to the steps of this method is created and recorded on the ROM 33 of the control device 30 or a recording medium. The hydrogen filling control can be performed by executing this computer program. Hydrogen filling control according to Mode Example 1 and Mode Example 2 will be described below. As described above, a computer program based on this hydrogen filling control is recorded on the ROM 33 of the control device 30 or a recording medium and thus functions as one component of the hydrogen storage device 20.

### 4.1. Mode Example 1

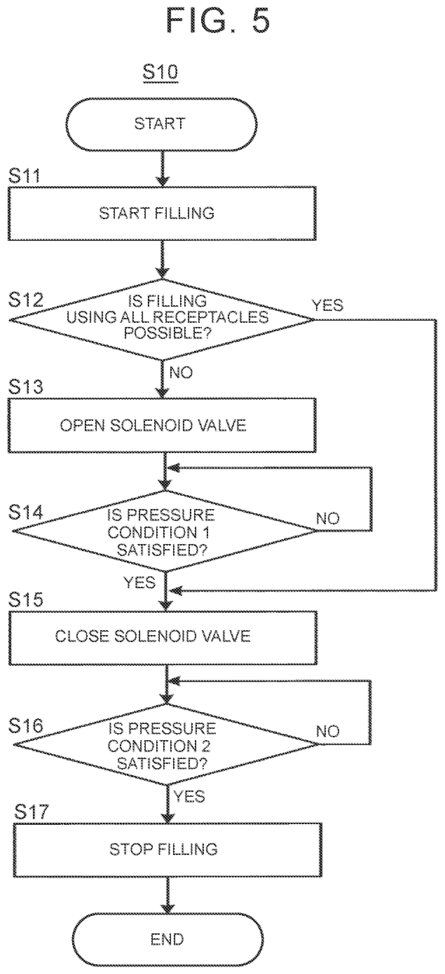

FIG. 5 is a flowchart of hydrogen filling control S10 according to Mode Example 1. As can be seen from FIG. 5, the hydrogen filling control S10 includes steps S11 to S17. Each step will be described below.

### 4.1.1. Step S11

In step S11, the nozzle 53a of the hydrogen filling device 50 is connected to the receptacle 22, and hydrogen filling is started. Hydrogen filling (supply of hydrogen) is continuously performed until it is stopped in step S17. The solenoid valve 24 is closed in the initial state.

### 4.1.2. Step S12

In step S12, it is determined whether hydrogen filling can be performed using both receptacles 22a, 22b. When hydrogen filling can be performed using both receptacles 22a, 22b, the determination result is Yes, and the process proceeds to step S15. When hydrogen filling needs to be performed using only one of the receptacles 22a, 22b, the determination result is No, and the process proceeds to step S13.

An example of the case where hydrogen filling can be performed using both receptacles 22 (determination result is Yes) is when a plurality of hydrogen filling devices is available for use, the nozzles 53a of the hydrogen filling devices 50 are connected to the receptacles 22a, 22b (the nozzle 53a is connected to the receptacle 22a and the nozzle 53a is connected to the receptacle 22b), and hydrogen filling can be performed normally. An example of the case where hydrogen filling needs to be performed using one of the receptacles 22 (determination result is No) is a case where only one hydrogen filling device 50 is available for use and the nozzle 53a of the hydrogen filling device 50 is connected to only either the receptacle 22a or the receptacle 22b. Even when the nozzles 53a are connected to both receptacles 22a, 22b, the determination result will be No when, for example, an O-ring of one of the receptacles 22a, 22b is broken and hydrogen filling can be performed only with the other receptacle.

The communication devices 25 are connected to the control device 30 as described above, and the determination in step S12 can be made based on information acquired from the hydrogen refueling station (hydrogen filling device(s) 50) through the communication devices 25.

### 4.1.3. Step S13

When No in step S12, the solenoid valve 24 is opened in step S13. As a result, the distributors 23a, 23b communicate with each other, and the independent hydrogen flow paths communicate with each other, so that all the hydrogen tanks 21 can be filled with hydrogen from one of the two receptacles 22.

### 4.1.4. Step S14

In step S14, it is determined whether a pressure condition 1 is satisfied in the situation where hydrogen filling is being performed with the solenoid valve 24 opened in step S13. Whether the pressure condition 1 is satisfied is determined based on pressure values. Specifically, the control device 30 acquires pressure data acquired by the pressure sensors 26a, 26b for the distributors 23a, 23b and performs calculations to determine whether the pressure condition 1 is satisfied.

An example of the pressure condition 1 is that Pₐ and P_{b} satisfy a threshold indicating that the hydrogen tanks have been filled with hydrogen to some extent and the absolute value of the difference between Pₐ and P_{b} is within a predetermined threshold, where Pₐ is the pressure in the distributor 23a, and P_{b} is the pressure in the distributor 23b. Therefore, when the pressure condition 1 is satisfied, it means that all the hydrogen tanks 21 have been filled with hydrogen to about the same certain level or higher at this point.

When it is determined in step S14 that the pressure condition 1 is satisfied, the determination result is Yes, and the process proceeds to step S15. When it is determined in step S14 that the pressure condition 1 is not satisfied, the determination result is No, and step S14 is repeated. As described above, hydrogen filling continues while the determination result of step S14 is No.

### 4.1.5. Step S15

When Yes in step S14, namely when hydrogen filling satisfies the pressure condition 1, the solenoid valve 24 is closed in step S15. The process then proceeds to step S16. When Yes in step S12, the process proceeds to step S15. In this case, hydrogen filling is being performed with the solenoid valve 24 kept closed.

### 4.1.6. Step S16

In step S16, it is determined whether a pressure condition 2 is satisfied in the situation where hydrogen filling is being performed with the solenoid valve 24 closed in step S15. Whether the pressure condition 2 is satisfied is determined based on pressure values. Specifically, the control device 30 acquires pressure data acquired by the pressure sensors 26a, 26b for the distributors 23a, 23b and performs calculations to determine whether the pressure condition 2 is satisfied.

An example of the pressure condition 2 is that Pₐ and P_{b} satisfy a threshold indicating that the hydrogen tanks have been filled with hydrogen to some extent, where Pₐ is the pressure in the distributor 23a, and P_{b} is the pressure in the distributor 23b. Therefore, when the pressure condition 2 is satisfied, it means that all the hydrogen tanks 21 have been filled with hydrogen to a required level at this point. In this case, Pₐ and P_{b} in the pressure condition 2 of step S16 are equal to or higher than Pₐ and P_{b} in the pressure condition 1 of step S14, respectively.

When it is determined in step S16 that the pressure condition 2 is satisfied, the determination result is Yes, and the process proceeds to step S17. When it is determined in step S16 that the pressure condition 2 is not satisfied, the determination result is No, and step S16 is repeated. As described above, hydrogen filling continues while the determination result of step S16 is No.

### 4.1.7. Step S17

In step S17, hydrogen filling is stopped. The hydrogen filling control is ended.

### 4.2. Mode Example 2

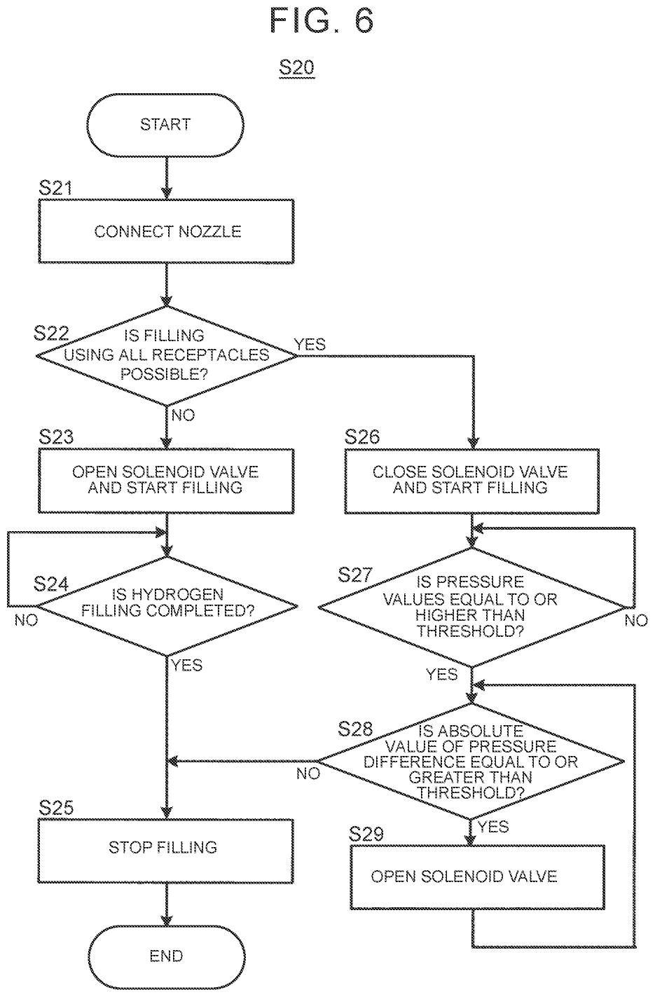

FIG. 6 is a flowchart of hydrogen filling control S20 according to Mode Example 2. As can be seen from FIG. 6, the hydrogen filling control S20 includes steps S21 to S29. Each step will be described below.

### 4.2.1. Step S21

In step S21, the nozzle 53a of the hydrogen filling device 50 is connected to the receptacle 22.

### 4.2.2. Step S22

In step S22, it is determined whether hydrogen filling can be performed using both receptacles 22a, 22b. When hydrogen filling can be performed using both receptacles 22a, 22b, the determination result is Yes, and the process proceeds to step S26. When hydrogen filling needs to be performed using only one of the receptacles 22a, 22b, the determination result is No, and the process proceeds to step S23.

An example of the case where hydrogen filling can be performed using both receptacles 22 (determination result is Yes) is a case where a plurality of hydrogen filling devices 50 is available for use, the nozzles 53a of the hydrogen filling devices 50 are connected to the receptacles 22a, 22b (the nozzle 53a is connected to the receptacle 22a and (the nozzle 53a is connected to the receptacle 22b), and hydrogen filling can be performed normally.

An example of the case where hydrogen filling needs to be performed using one of the receptacles 22 (determination result is No) is a case where only one hydrogen filling device 50 is available for use and the nozzle 53a of the hydrogen filling device 50 is connected to only either the receptacle 22a or the receptacle 22b. Even when the nozzles 53a are connected to both receptacles 22a, 22b, the determination result will be No when, for example, an O-ring of one of the receptacles 22a, 22b is broken and hydrogen filling can be performed only with the other receptacle.

The communication devices 25 are connected to the control device 30 as described above, and the determination in step S22 can be made based on information acquired from the hydrogen refueling station (hydrogen filling device(s) 50) through the communication devices 25.

### 4.2.3. Step S23

When No in step S22, the solenoid valve 24 is opened and hydrogen filling is started in step S23. By this step S23, the independent hydrogen flow paths communicate with each other, and all the hydrogen tanks 21 are filled with hydrogen through one receptacle 22. Hydrogen filling is continued until it is stopped in step S25.

### 4.2.4. Step S24

In step S24, it is determined whether hydrogen filling is completed in the situation where hydrogen filling is being performed with the solenoid valve 24 opened in step S23. Whether hydrogen filling is completed is determined based on pressure values. Specifically, the control device 30 acquires pressure data acquired by the pressure sensors 26a, 26b for the distributors 23a, 23b and performs calculations to determine whether hydrogen filling is completed.

An example of the condition that hydrogen filling is completed is that Pₐ and P_{b} are higher than a threshold (e.g., 70 MPa) indicating that the hydrogen tanks have been filled with hydrogen to some extent, where Pₐ is the pressure in the distributor 23a, and P_{b} is the pressure in the distributor 23b. Therefore, when the condition that hydrogen filling is completed is satisfied, it means that all the hydrogen tanks 21 have been filled with hydrogen to a required level at this point.

When it is determined in step S24 that hydrogen filling is completed, the determination result is Yes, and the process proceeds to step S25. Hydrogen filling is stopped in step S25. When it is determined in step S24 that hydrogen filling is not completed, the determination result is No, and step S24 is repeated. As described above, hydrogen filling continues while the determination result of step S24 is No.

### 4.2.5. Step S26

When Yes in step S22, the solenoid valve 24 is closed (kept closed) and hydrogen filling is started in step S26. By this step S26, in each independent hydrogen flow path, the hydrogen tanks 21 allocated to the receptacle 22 are filled with hydrogen through this receptacle 22. Hydrogen filling is continued until it is stopped in step S25.

### 4.2.6. Step S27

In step S27, it is determined whether pressures are equal to or higher than a threshold in the situation where hydrogen filling is being performed with the solenoid valve 24 closed in step S26. Specifically, the control device 30 acquires pressure data acquired by the pressure sensors 26a, 26b for the distributors 23a, 23b and performs calculations to determine whether the pressures are equal to or higher than the threshold.

An example of the condition that the pressures are equal to or higher than the threshold is that Pₐ and P_{b} are higher than a threshold (e.g., 68 MPa) indicating that the hydrogen tanks have been filled with hydrogen to some extent, where Pₐ is the pressure in the distributor 23a, and P_{b} is the pressure in the distributor 23b. Therefore, when the condition that the pressures are equal to or higher than the threshold is satisfied, it is determined that all the hydrogen tanks 21 have been filled with hydrogen to a required level at this point.

When it is determined in step S27 that the pressures are equal to or higher than the threshold, the determination result is Yes, and the process proceeds to step S28. When it is determined in step S27 that the pressures are not equal to or higher than the threshold, the determination result is No, and step S27 is repeated. As described above, hydrogen filling continues while the determination result of step S27 is No.

### 4.2.7. Step S28

When it is determined in step S27 that the pressures are equal to or higher than the threshold in the situation where hydrogen filling is being performed with the solenoid valve 24 closed, it is determined in step S28 whether the absolute value of the difference between Pₐ and P_{b} is equal to or greater than a threshold. Specifically, the control device 30 acquires pressure data acquired by the pressure sensors 26a, 26b for the distributors 23a, 23b and performs calculations to determine whether the absolute value of the difference between Pₐ and P_{b} is equal to or greater than the threshold.

An example of the condition that the absolute value of the pressure difference is equal to or greater than the threshold is that the absolute value of the difference between Pₐ and P_{b} is equal to or greater than a threshold (e.g., 1 MPa). When the absolute value of the pressure difference is equal to or greater than the threshold, it means that there is a difference in hydrogen filling level between the hydrogen tanks at this point.

When it is determined in step S28 that the absolute value of the pressure difference is equal to or greater than the threshold, the determination result is Yes, and the process proceeds to step S29. When it is determined in step S28 that the absolute value of the pressure difference is not equal to or greater than the threshold, the determination result is No, and the process proceeds to step S25. In step S25, hydrogen filling is stopped.

### 4.2.8. Step S29

In step S29, the solenoid valve 24 is opened. As a result, the independent hydrogen flow paths communicate with each other, and all the receptacles 22 (all the hydrogen filling devices 50) communicate with all the hydrogen tanks 21. Therefore, when there is a differential pressure between the hydrogen tanks 21, the differential pressure can be reduced.

After the solenoid valve 24 is opened in step S29, the process returns to step S28. Hydrogen filling is performed with the solenoid valve 24 kept open until the determination result of step S28 becomes No.

### 5. Effects Etc

According to the present disclosure, hydrogen tanks can be expected to be efficiently and sufficiently filled with hydrogen according to a condition of the hydrogen filling device in the case where the hydrogen storage device includes a plurality of receptacles and a plurality of hydrogen tanks.

The example described above is an example in the hydrogen storage device includes two receptacles and four hydrogen tanks. However, the number of receptacles and the number of hydrogen tanks are not particularly limited as long as the number of receptacles and the number of hydrogen tanks are two or more. That is, the hydrogen storage device may have three or more independent hydrogen flow paths each formed by a single receptacle and a hydrogen tank(s) allocated to this receptacle, and may include two or more solenoid valves.

In the above description, two hydrogen tanks are allocated to one receptacle in each independent hydrogen flow path. However, the number of hydrogen tanks allocated to each receptacle need not necessarily be the same and may be different. For example, the number of hydrogen tanks allocated to each receptacle can be adjusted according to the capacity of the hydrogen tanks.

What is claimed is:

1. A hydrogen storage device that is included in a vehicle using hydrogen as fuel and that is configured to store hydrogen supplied from a hydrogen filling device, the hydrogen storage device comprising:
a plurality of receptacles configured such that a nozzle of the hydrogen filling device is connected to each of the receptacles;
a plurality of hydrogen tanks;
a flow path through which hydrogen flows from the receptacles toward the hydrogen tanks;
a solenoid valve located in the flow path; and
a control device, wherein
the receptacles include a first receptacle and a second receptacle,
the hydrogen tanks include at least one first hydrogen tank and at least one second hydrogen tank,
the flow path includes an independent first flow path connecting the first receptacle and the at least one first hydrogen tank, and an independent second flow path connecting the second receptacle and the at least one second hydrogen tank,
by opening and closing the solenoid valve, the independent first flow path and the independent second flow path are switched between a state in which the independent first flow path and the independent second flow path communicate with each other and a state in which the independent first flow path and the independent second flow path do not communicate with each other, and
the control device is configured to control the opening and closing of the solenoid valve, and is configured to perform a calculation for determining whether to open or close the solenoid valve, based on a condition of the hydrogen filling device connected to at least one of the receptacles.

2. The hydrogen storage device according to claim 1, wherein:
the flow path includes a third flow path connecting the independent first flow path and the independent second flow path; and
the solenoid valve is located in the third flow path.

3. The hydrogen storage device according to claim 1, wherein the control device is configured to perform control to open the solenoid valve when there is at least one of the receptacles to which hydrogen is not supplied.

4. The hydrogen storage device according to claim 1, further comprising a pressure sensor that is configured to measure a pressure in the flow path, wherein the control device is configured to acquire a pressure value from the pressure sensor, and is configured to perform control to open the solenoid valve when an absolute value of a pressure difference between the independent first flow path and the independent second flow path is equal to or greater than a predetermined value.

5. A vehicle comprising:
the hydrogen storage device according to claim 1; and
a fuel cell system configured to be supplied with hydrogen from the hydrogen tanks of the hydrogen storage device to generate electricity.
